(19) United States
(12) Patent Application Publication
(10) Pub. No.: US 2020/0160260 A1
(43) Pub. Date: May 21, 2020

(54) SYSTEM, METHOD, AND APPARATUS TO FACILITATE THE TRANSFER OF ITEMS

(71) Applicant: Chargerback, Inc., Carson City, NV (US)

(72) Inventors: Brian Colodny, Reno, NV (US); Michael McLaughlin, Gardnerville, NV (US)

(21) Appl. No.: 16/752,649

(22) Filed: Jan. 26, 2020

Related U.S. Application Data
(63) Continuation of application No. 14/497,095, filed on Sep. 25, 2014, now abandoned.

(51) Int. Cl. G06Q 10/08

(52) U.S. Cl. CPC G06Q 10/087; G06Q 10/083

(57) ABSTRACT

In one embodiment, a system, method, and apparatus to facilitate the transfer of items between different establishment locations of an entity having a lost item database storing a record for each of a plurality of lost items, wherein, for each lost item, the record having at least a lost item description, a lost item establishment location, and a destination location; a found item database including a record for each of a plurality of found items, wherein, for each found item, the record having at least a found item description and a found item location; at least one server configured to search the found item database for a found item that matches a lost item in the lost item database; and a transfer manager configured to manage transfer of the found item from the found item establishment location to the destination location.

### CROSS REFERENCE TO RELATED APPLICATION

This application is a continuation of U.S. patent application Ser. No. 14/497,095, filed Sep. 25, 2014, and entitled “SYSTEM, METHOD, AND APPARATUS TO FACILITATE THE TRANSFER OF ITEMS,” which is hereby incorporated herein by reference.

### BACKGROUND OF THE INVENTION

Everyone has forgotten a personal item at least once. Once lost, the items may or may not ever be returned to the rightful owner. For example, when on vacation, a user may forget an item(s) in a hotel room. In another example, a customer may forget an item in an airplane, rental car, sporting event, or any other establishment or event. The most common item left in hotel rooms is chargers, such as a cell phone charger. However, any other valuable items may also be lost or left behind such as clothing, cell phones, jewelry, and the like.

Typically airlines do not have the capability to hold all lost items that are found. Thus, the items are transferred to a custody center (generally a location different from the location where the item was found) and inevitably is “lost” within the custody center. There is no chain of custody provided for the items nor is the location of where the found items are stored and tracked. Thus, since there is no tracking or accountability, theft of found items can be high.

If the airline needs to return the found item to the customer, it needs to contact a shipping company, such as FedEx, UPS, or package the item and drop it off at a post office. The customer is typically charged for the return of their lost item, which is typically very expensive since airlines generally do not have favorable shipping rates. Since the process is laborious and costly, either the airline simply does not make the effort to return the lost item to the customer and/or the customer decides to forgo the lost item to simply buy a new item at a lower cost.

### SUMMARY

Embodiments of the invention allow establishments to efficiently transfer found items between different locations of the same establishment. Companies may operate in different cities and/or different countries. Thus, the ability to efficiently record, track, and transfer items between the different offices would assist in the facilitation of returning found items to its rightful owner, which may be a customer.

In one embodiment, a system for the transfer of found items between different establishment locations of an entity may have a lost item database storing a record for each of a plurality of lost items, wherein, for each lost item, the record having at least a lost item description, a lost item establishment location, and a destination location; a found item database including a record for each of a plurality of found items, wherein, for each found item, the record having at least a found item description and a found item location; at least one server configured to search the found item database for a found item that matches a lost item in the lost item database; and a transfer manager configured to manage transfer of the found item from the found item establishment location to the destination location.

In one embodiment, a method for transferring found items may include receiving, at a server, a lost item report generated at a first establishment location via a network, the lost item report including at least a lost item description and a destination location; determining, by the server, if a lost item description matches a found item description, the found item description located in at least one of a plurality of found item reports; determining if a found item location in the found item report matches a destination location in the lost item report if it is determined that a lost item description matches a found item description; transmitting a transfer request to transfer the found item from the found item location to the destination location if it is determined that the found item location does not match the destination location; and facilitating transfer of the found item to the destination location.

In one embodiment, a program storage device readable by a machine tangibly embodying a program of instructions executable by the machine to perform a method for transferring goods, the method may comprise computer program code for receiving a lost item report generated at a first establishment location, the lost item report including at least a lost item description and a destination location; computer program code for identifying a found item having a found item description that matches the lost item description, the found item description located in at least one of a plurality of found item reports, each of the plurality of found item reports including at least a second establishment location where the corresponding found item is located; computer program code for determining if the second establishment location is the same as the destination location; computer program code for transmitting a transfer request to transfer the found item from the second establishment location to the destination location if it is determined that the second establishment location is not the same as the destination location; and computer program code for facilitating transfer of the found item to the destination location.

Other aspects and advantages of the invention will become apparent from the following detailed description taken in conjunction with the accompanying drawings which illustrate, by way of example, the principles of the invention.

### BRIEF DESCRIPTION OF THE DRAWINGS

The accompanying drawings, which are incorporated into and constitute a part of this specification, illustrate one or more example embodiments and, together with the description of example embodiments, serve to explain the principles and implementations.

In the drawings:

FIG. 1 illustrates an example system for the transfer of found items.

FIGS. 2A and 2B illustrate an example method for transferring found items.

FIG. 3 illustrates an example lost item report.

FIG. 4 illustrates an example found item report.

FIG. 5 illustrates an example graphical user interface to facilitate transfer of a found item.

FIG. 6 illustrates an example transfer request form.

FIGS. 7A-7C further illustrate the example transfer request form of FIG. 6.

FIG. 8 illustrates an example graphical user interface illustrating a list of existing transfer requests.

FIG. 9 illustrates a block diagram of a computing device according to one embodiment.

### DESCRIPTION OF EXAMPLE EMBODIMENTS

Embodiments are described herein in the context of a system, method, and apparatus for the transfer of items. The following detailed description is illustrative only and is not intended to be in any way limiting. Other embodiments will readily suggest themselves to such skilled persons having the benefit of this disclosure. Reference will now be made in detail to implementations as illustrated in the accompanying drawings. The same reference indicators will be used throughout the drawings and the following detailed description to refer to the same or like parts.

In the interest of clarity, not all of the routine features of the implementations described herein are shown and described. It will, of course, be appreciated that in the development of any such actual implementation, numerous implementation-specific decisions must be made in order to achieve the developer's specific goals, such as compliance with application- and business-related constraints, and that these specific goals will vary from one implementation to another and from one developer to another. Moreover, it will be appreciated that such a development effort might be complex and time-consuming, but would nevertheless be a routine undertaking of engineering for those of ordinary skill in the art having the benefit of this disclosure.

In accordance with the present invention, the components, process steps, and/or data structures may be implemented using various types of operating systems, computing platforms, computer programs, and/or general purpose machines. In addition, those of ordinary skill in the art will recognize that devices of a less general purpose nature, such as hardwired devices, field programmable gate arrays (FPGAs), application specific integrated circuits (ASICs), or the like, may also be used without departing from the scope and spirit of the inventive concepts disclosed herein.

Embodiments of the invention relate to the transfer of found items between different locations of a company or between multiple different companies. Companies may operate in different locations and/or different countries. Thus, the ability to efficiently record, track, and transfer items between the different offices would assist in the facilitation of returning found items to its owner.

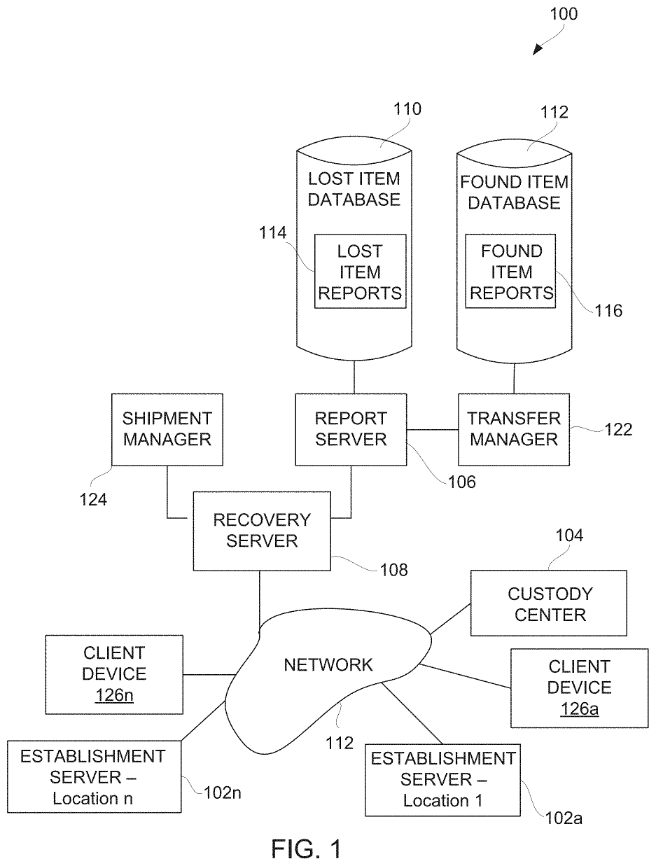

Several embodiments of the invention are discussed below with reference to FIGS. 1-9. However, those skilled in the art will readily appreciate that the detailed description given herein with respect to these figures is for explanatory purposes as the invention can extend beyond these limited embodiments.

FIG. 1 illustrates an example system for the transfer of found items. The system 100 can have a plurality of establishment servers based in different locations 102a,n (where n is n integer). The establishment server 102a,n may be associated with any type of business such as a hotel, supermarket, airport, airline company, coffee shop, car rental company, school (e.g. primary school, university, college, and the like), cruise ship, movie theaters, parks and campgrounds, shopping centers, business centers, private residences, or any other location where a lost item may be found. Furthermore, the establishment server may also be associated with an event, such as a football game, convention, seminar, races (i.e. triathlon, running, biking, and the like), and any other events.

For example, the establishment may be a hotel chain. The hotel chain may have a location in San Jose, Calif.; Salt Lake City, Utah; Denver, Colo.; Shanghai, China; and Bombay, India. In another example, the establishment may be an airline company. The airline company may have its headquarter in San Francisco, Calif., but fly to different location such as Los Angeles, Calif.; New York, N.Y.; Memphis, Tenn.; Paris, France; and London, United Kingdom. Thus, although illustrated with two locations, this is not intended to be limiting as an establishment may be located or provide goods/services at multiple locations throughout the world. In still another example, a ski resort with a lodge may also have a hotel associated with it. The lodge and hotel may be in the same city, different city, or just a few hundred feet from each other. Thus, the ability to track and facilitate the transfer of found items between the lodge and the hotel may assist in the return of the found item to its owner.

The establishment may have a custody center 104 where found items are centralized and stored. Generally, it may not be possible for an establishment to house and store all found items. Thus, the establishment may utilize a centralized location or custody center 104 to house the found items. For example, an airline may have a custody center 104 at a specific city where all found items are stored since it is generally not possible for airlines to store found items at each location it flies to. Once a found item is lost, the establishment may immediately or after a short while (i.e. a predetermined period of time such as between 1-7 days) be transferred to the custody center 104. At the custody center 104, the found item may be tagged, assigned a unique identifier and a storage location, and stored at the storage location until it is claimed or discarded. This enables the establishment to account for and maintain a chain of custody of the found items.

Each establishment server 102a,n may communicate with a recovery server 108 via network 112 via any known wired or wireless manner. In another embodiment, client device 126a,n may also communicate with recovery server 108 via network 112 via any known wired or wireless manner. In this embodiment, the customer or client device 126a,n may self-report the lost item using a lost item report.

When a lost item is reported to the establishment server 102a,n, the establishment server 102a,n or client device 126a,n may generate a lost item report by inputting information or data into data fields. The lost item report may have data fields containing information such as customer information, description of the lost item, location where the lost item was lost, a destination location, and any other desired information. The customer information may include the customer's name, phone number, electronic mail address, mailing address, and any other desired information.

The description of the lost item may include a general descriptive term as well as specific descriptive terms of the lost item to be used as keywords during a keyword search. For example, a general descriptive term may be a “Phone charger” and the specific descriptive term may be “Black iPhone 5 phone charger”. In another example, the general descriptive term may be “clothing” and the specific descriptive term may be “black and white adult socks”. The lost item description may also include an image of the lost item to enhance or increase the chances for identification of the lost item. The detailed descriptive terms may include any information such as color, shape, manufacturer, and any other characteristic of the lost item. Terms and keywords are further described in detail in United States Patent Application titled “SYSTEM, METHOD, AND APPARATUS FOR LOCATING AND MERGING DOCUMENTS”, application Ser. No. 14/158,658, filed Jan. 17, 2014, which is hereby incorporated by reference for all purposes.

The lost item report may also include the location where the lost item was lost. The location of where the item was lost may include a business name, room number, seat number, and/or additional location information or data of the last known location of the lost item. The location may be a general location, such as “Flight 123”, or “Section A in the pool area”. The location may also be a specific location, such as “Behind Seat 33A” or “Under red couch in lobby”.

A destination location may also be included to indicate a location of where the customer would like to pick up or have the found item transferred to. For example, the customer may have flown from Charlotte, N.C. to San Diego, Calif. for a one-day meeting. After flying back to Charlotte, the customer remembered that he left his phone charger on the plane to San Diego. The customer may notify the agent in Charlotte of the lost phone charger. Thus, the destination location may be Charlotte, N.C. as that is where the customer lives and is able to pick up the found item.

The lost item report may also include a return option data field. The return option data field may include information of how the customer would like the item returned. For example, the customer may want to personally pick up the found item, have the found item mailed to a specific address, or any other known delivery options.

The recovery server 108 may receive the lost item report and transmit it to the report server 106 to be stored in a lost item database 110. The lost item database 110 may be configured to store a plurality of lost item reports 114.

When the lost item is found and becomes a found item, a found item report may be generated by the establishment server 102a,n. The found item report may include data fields such as founder information, found location, found item description, and any other information about the found item. The founder information may include information of the person that found the found item such as name, phone number, address, electronic mail address, and any other information about the founder. The found location may be the location of where the item was found. The location of where the item was found may include a business name, room number, seat number, and/or additional location information or data of where the item was found. The location may be a general location, such as “Flight 123”, or “Section A in the pool area”. The location may also be a specific location, such as “Behind Seat 33A” or “Under red couch in lobby”.

The found item report may include a data field to input a found item description. The description of the lost item may include a general descriptive term as well as specific descriptive terms of the lost item to be used as keywords during a keyword search. For example, a general descriptive term may be a “Phone charger” and the specific descriptive term may be “Black iPhone 5 phone charger”. In another example, the general descriptive term may be “clothing” and the specific descriptive term may be “black and white adult socks”. The detailed descriptive terms may include any information such as color, shape, manufacturer, and any other characteristic of the lost item. Terms and keywords are further described in detail in United States Patent Application titled “SYSTEM, METHOD, AND APPARATUS FOR LOCATING AND MERGING DOCUMENTS”, application Ser. No. 14/158,658, filed Jan. 17, 2014, which is hereby incorporated by reference for all purposes. The found item description may also include an image of the found item to enhance or increase the chances for identification or a match with a lost item.

The recovery server 108 may receive the found item report and transmit it to the report server 106 to be stored in a found item database 112. The found item database 112 may be configured to store a plurality of found item reports 116.

Since not all found items may be stored at the establishment locations 102a,n, the found items may be transferred to a custody center 104. Thus, the found item storage location may be periodically updated to indicate where the found item is stored. At the custody center 104, the found item may be tagged, assigned a unique identifier and a storage location, and stored at the storage location until it is claimed or discarded.

The lost item reports 114 and the found item reports 116 may be compared to determine if there is a match. In one embodiment, the lost item description and the found item description may be sorted and compared to determine whether there is a match. Any known comparison method may be used to compare the lost item reports 114 with the found item reports 116, such as keyword searches.

In one example, if a first image is associated with the lost item report and a second image is associated with the found item report, the images may be scanned and compared. Based upon the match percentage resulting from the image scan, the lost item may be recovered. For example, if the match percentage is between 75% to 100%, then there is a high probability that the lost item may be located. If the match percentage is between 50%-75%, there is a probability that the lost item may be located. If the match percentage is between 25%-50%, there is a small probability that the lost item may be located. If the match percentage is between 0%-25%, there is most likely not a match. In one embodiment, a timestamp may be provided for each of the lost item report and/or the found item report so that after a predetermined amount of time (e.g. 30 days, 3 months, 6 months), older lost item reports 114 and found item reports 116 may be removed and deleted. In another embodiment, the lost item date and/or timestamp may be compared with the found item date and/or timestamp to determine if the lost item report 114 matches a found item report 116.

If a found item report 116 matches a lost item report 114, the lost item may be considered a recovered item. The lost item report 114 and found item report 116 may have a status indicator to indicate that a match has been found.

Once a match has been found, recovery server 108 may transmit a recovery notification to establishment server 102a,n and/or client device 126a,n. In one embodiment, the notification may include a customized and/or personalized message to the client device 126a,n. For example, the notification may include a customized pre-formatted response that is transmitted to the client. In another example, the message may be a text, audio, attachment or any other type of notification message.

The destination location in the lost item report 114 may then be compared with the found item storage location located in the found item report 116. If the destination location is the same as the found item storage location, no transfer of the item is necessary. However, if the destination location is different from the found item storage location, a transfer request may be initiated by a transfer manager 122. Transfer manager 122 may transmit a transfer request to the establishment server 102a,n and/or custody center 104 via recovery server 108.

For example, if the destination location is San Diego, Calif. and the found item location is stored in a custody center 104 in Austin, Tex., the transfer manager 122 may transmit a transfer request to the custody center 104 and establishment server located in Austin, Tex. to transfer the found item to San Diego, Calif. In another example, if the destination location is Paris, France and the found item location is in Los Angeles, Calif., transfer manager 122 may transmit a transfer request to the establishment location in Los Angeles, Calif. to transfer the found item to Paris, France.

In one embodiment, a shipment manager 124 may facilitate delivery of the found item to the customer. In another embodiment, shipment manager 124 may facilitate transfer of the found item to the destination location. For example, the found item may be placed on a plane destined for the destination location. In another example, the return option data field in the lost item report 114 may indicate the customer would like the found item shipped back to a specific address. In one embodiment, recovery server 108 may transmit shipping and payment options to client device 126a-n. The customer or client device 126a-n may then select the preferred shipping method and provide payment information to pay for shipping costs. The shipping method may also include different shipping options such as the purchase of insurance, delivery confirmation, expedited delivery, and the like. Shipment methods and options are further discussed in United States Patent Application titled “SYSTEM AND METHOD FOR INVENTORY AND RETURN OF LOST ITEMS”, application Ser. No. 13/224,244, filed Sep. 1, 2011, which is hereby incorporated by reference for all purposes.

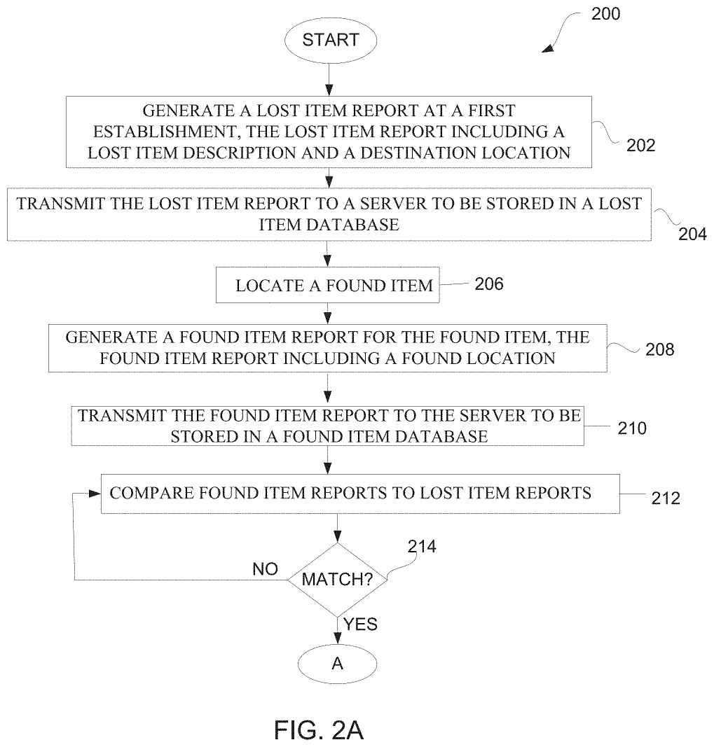

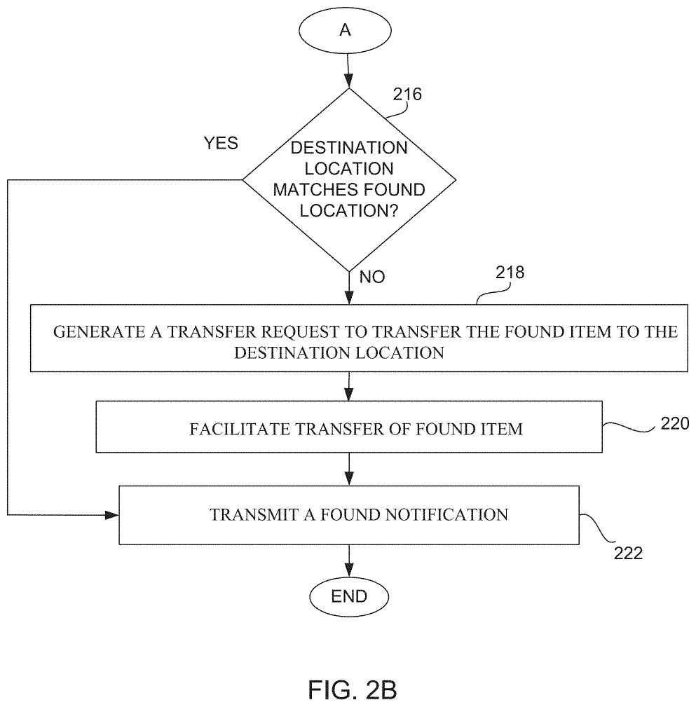

FIGS. 2A and 2B illustrate an example method for transferring found items. Referring to FIG. 2A, the method 200 may start with the generation of a lost item report at a first establishment location at 202. The lost item report may include at least a lost item description and a destination location. The establishment location may be associated with any type of business such as a hotel, supermarket, airport, airline company, coffee shop, car rental company, school (e.g. primary school, university, college, and the like), cruise ship, movie theaters, parks and campgrounds, shopping centers, business centers, private residences, or any other location where a lost item may be found. Furthermore, the establishment server may also be associated with an event, such as a football game, convention, seminar, races (i.e. triathlon, running, biking, and the like), and any other events.

For example, the establishment may be a hotel chain. The hotel chain may have a location in San Jose, Calif.; Salt Lake City, Utah; Denver, Colo.; Shanghai, China; and Bombay, India. In another example, the establishment may be an airline company. The airline company may have its headquarter in San Francisco, Calif., but fly to different location such as Los Angeles, Calif.; New York, N.Y.; Memphis, Tenn.; Paris, France; and London, United Kingdom. Thus, although illustrated with two locations, this is not intended to be limiting as an establishment may be located or provide goods/services at multiple locations throughout the world. In still another example, a ski resort with a lodge may also have a hotel associated with it. The lodge and hotel may be in the same city, different city, or just a few hundred feet from each other. Thus, the ability to track and facilitate the transfer of found items between the lodge and the hotel may assist in the return of the found item to its owner.

The establishment may have a custody center where found items are centralized and stored. Generally, it may not be possible for an establishment to house and store all found items. Thus, the establishment may utilize a centralized location or custody center to house the found items. For example, an airline may have a custody center at a specific city where all found items are stored or housed since it is generally not possible for airlines to store found items at each location it flies to. Once a found item is lost, the establishment may immediately or after a short while (i.e. a predetermined period of time such as between 1-7 days) be transferred to the custody center. At the custody center, the found item may be tagged, assigned a unique identifier and a storage location, and stored at the storage location until it is claimed or discarded. This enables the establishment to account for and maintain a chain of custody of the found items.

When a lost item is reported to the establishment location, the establishment location may generate a lost item report by inputting information or data into a plurality of data fields. The lost item report may have data fields containing information such as customer information, description of the lost item, location where the lost item was lost, a destination location, and any other desired information. The customer information may include the customer's name, phone number, electronic mail address, mailing address, and any other desired information.

The description of the lost item may include a general descriptive term as well as specific descriptive terms of the lost item to be used as keywords during a keyword search. For example, a general descriptive term may be a “Phone charger” and the specific descriptive term may be “Black iPhone 5 phone charger”. In another example, the general descriptive term may be “clothing” and the specific descriptive term may be “black and white adult socks”. The detailed descriptive terms may include any information such as color, shape, manufacturer, and any other characteristic of the lost item. The lost item description may also include an image of the lost item to enhance or increase the chances for identification of the lost item.

The lost item report may also include the location where the lost item was lost. The location of where the item was lost may include a business name, room number, seat number, and/or additional location information or data of the last known location of the lost item. The location may be a general location, such as “Flight 123”, or “Section A in the pool area”. The location may also be a specific location, such as “Behind Seat 33A” or “Under red couch in lobby”.

A destination location may also be included to indicate a location of where the customer would like to pick up or have the found item transferred to. For example, the customer may have flown from Charlotte, N.C. to San Diego, Calif. for a one-day meeting. After flying back to Charlotte, the customer remembered that he left his phone charger on the plane to San Diego. The customer may notify the agent in Charlotte of the lost phone charger. Thus, the destination location may be Charlotte, N.C. as that is where the customer lives and is able to pick up the found item.

The lost item report may also include a return option data field. The return option data field may include information of how the customer would like the item returned. For example, the customer may want to personally pick up the found item, have the found item mailed to a specific address, or any other known delivery options.

The lost item report may then be transmitted to a server to be stored in a lost item database at 204. The server, such as recovery server 108 illustrated in FIG. 1 may receive the lost item report to be stored in a database, such as lost item database 110 illustrated in FIG. 1. The lost item database may be configured to store a plurality of lost item reports.

A found item may be located at 206. In other words, the lost item is found and becomes a found item. A found item report may be generated for the found item at 208. The found item report may include at least a found location. The found item report may include data fields such as founder information, found location, found item description, and any other information about the found item. The founder information may include information of the person that found the found item such as name, phone number, address, electronic mail address, and any other information about the founder. The found location may be the location of where the item was found. The location of where the item was found may include a business name, room number, seat number, and/or additional location information or data of where the item was found. The location may be a general location, such as “Flight 123”, or “Section A in the pool area”. The location may also be a specific location, such as “Behind Seat 33A” or “Under red couch in lobby”.

The found item report may include a data field to input a found item description. The description of the lost item may include a general descriptive term as well as specific descriptive terms of the lost item to be used as keywords during a keyword search. For example, a general descriptive term may be a “Phone charger” and the specific descriptive term may be “Black iPhone 5 phone charger”. In another example, the general descriptive term may be “clothing” and the specific descriptive term may be “black and white adult socks”. The detailed descriptive terms may include any information such as color, shape, manufacturer, and any other characteristic of the lost item. The found item description may also include an image of the found item to enhance or increase the chances for identification or a match with a lost item.

The found item report may be transmitted to the server to be stored in a found item database at 210. The server may be, for example, recovery server 108 illustrated in FIG. 1. The found item database may be configured to store a plurality of found item reports.

Since not all found items may be stored at the establishment locations, the found items may be transferred to a custody center. Thus, the found item storage location may be periodically updated to indicate where the found item is at every moment. At the custody center, the found item may be tagged, assigned a unique identifier and a storage location, and stored at the storage location until it is claimed or discarded.

The lost item reports and the found item reports may be compared at 212 to determine if there is a match. In one embodiment, the lost item description and the found item description may be sorted or filtered and compared to determine whether there is a match. Any known comparison method may be used to compare the lost item reports with the found item reports, such as keyword searches.

In one example, if a first image is associated with the lost item report and a second image is associated with the found item report, the images may be scanned and compared. Based upon the match percentage resulting from the image scan, the lost item may be recovered. For example, if the match percentage is between 75% to 100%, then there is a high probability that the lost item may be located. If the match percentage is between 50%-75%, there is a probability that the lost item may be located. If the match percentage is between 25%-50%, there is a small probability that the lost item may be located. If the match percentage is between 0%-25%, there is most likely not a match.

In one embodiment, a timestamp may be provided for each of the lost item report and/or the found item report so that after a predetermined amount of time (e.g. 30 days, 3 months, 6 months), older lost item reports and found item reports may be removed and deleted. In another embodiment, the lost item date and/or timestamp may be compared with the found item date and/or timestamp to determine if the lost item report matches a found item report.

If a found item report matches a lost item report at 214, the lost item may be considered a recovered item. The lost item report and found item report may have a status indicator to indicate that a match has been found. If no match has been found at 214, the comparing may repeat at 212.

Referring now to FIG. 2B, once a match has been found at 214, the destination location in the lost item report may then be compared with the found item storage location located in the found item report at 216. If the destination location is the same as the found item storage location, no transfer of the item is necessary. A found or recovery notification may be transmitted at 222. The recovery notification may be transmitted to the establishment location and/or a client device associated with the owner. In one embodiment, the notification may include a customized and/or personalized message. For example, the notification may include a customized pre-formatted response that is transmitted to the client. In another example, the message may be a text, audio, attachment or any other type of notification message.

However, if the destination location is different from the found item location, a transfer request may be generated to transfer the found item to the destination location at 218. The transfer request may be initiated by, for example, a transfer manager 122 as illustrated in FIG. 1. The transfer request may be transmitted to the establishment location and/or custody center.

For example, if the destination location is San Diego, Calif. and the found item location is stored in a custody center in Austin, Tex., the transfer request may be transmitted to the custody center and establishment server in San Diego, Calif. to transfer the found item to San Diego, Calif. In another example, if the destination location may be located in Paris, France and the found item storage location may be in Los Angeles, Calif., the transfer request may be transmitted to the establishment location in Los Angeles, Calif. to transfer the found item to Paris, France.

Transfer of the found item to the destination location may be facilitated at 220. In one embodiment, the found item may be delivered directly to the customer. In another embodiment, the found item may be shipped to the destination location. For example, the found item may be placed on a plane destined for the destination location. In another example, the return option data field in the lost item report 114 may indicate the customer would like the found item shipped back to a specific address. In another embodiment, the return option data field in the lost item report may indicate how the customer would like the found item shipped back to him.

A found or recovery notification may then be transmitted at 222. The recovery notification may be transmitted to the establishment location and/or a client device associated with the owner. In one embodiment, the notification may include a customized and/or personalized message. For example, the notification may include a customized pre-formatted response that is transmitted to the client. In another example, the message may be a text, audio, attachment or any other type of notification message.

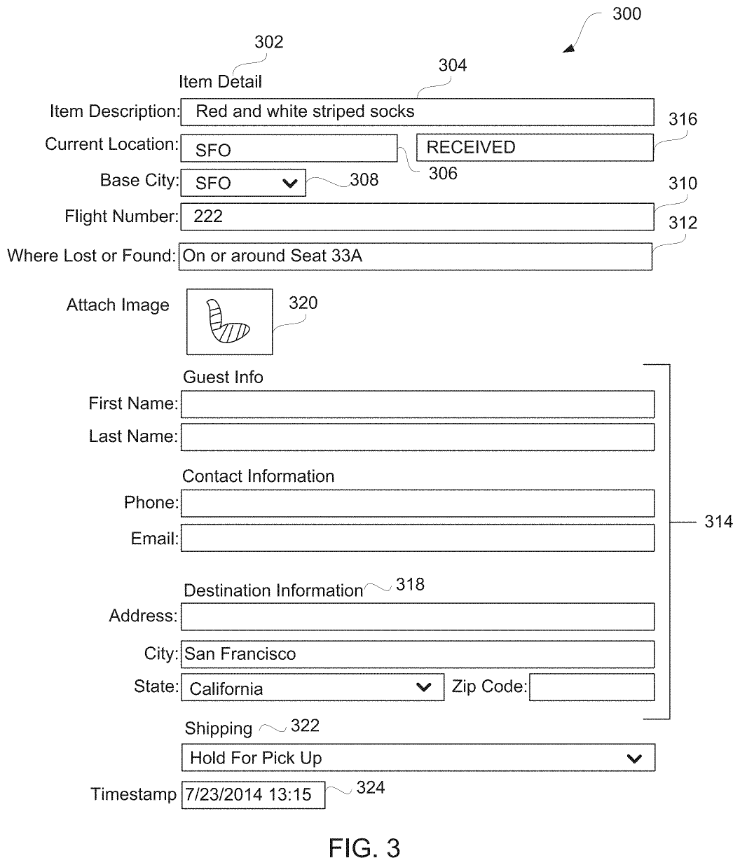

FIG. 3 illustrates an example lost item report. The lost item report 300 may have a plurality of data containing information such as customer information 314, item details 302 such as location where the lost item was lost 312, a destination location 318, and any other desired information. The customer information 314 may include the customer's name, phone number, electronic mail address, mailing address, and any other desired information.

The description of the lost item 302 may include a general descriptive term as well as specific descriptive terms 304 of the lost item to be used as keywords during a keyword search. As illustrated, the term may include general and specific descriptive terms such as “red and white striped socks” 304. In another example, a general descriptive term may be a “Phone charger” and the specific descriptive term may be “Black iPhone 5 phone charger”. In yet another example, the general descriptive term may be “clothing” and the specific descriptive term may be “black and white adult socks”. The detailed descriptive terms may include any information such as color, shape, manufacturer, and any other characteristic of the lost item. The lost item description may also include an image 320 of the lost item to enhance or increase the chances for identification of the lost item.

The lost item report 300 may also include the location where the lost item was lost 312. The location of where the item was lost may include a business name, room number, seat number, and/or additional location information or data of the last known location of the lost item. The location may be a general location, such as “Flight 123”, or “Section A in the pool area”. The location may also be a specific location, such as “On or around Seat 33A” 312″ or “Under red couch in lobby”.

In one example embodiment, the establishment illustrated in FIG. 3 may be an airline. Thus, other additional item detail data 302 may include the current location 306 of where the lost item report is generated, the base city 308 for the establishment, flight number 310 of the plane, location of the custody center for the airline, and any other desired information.

A destination location 318 may also be included to indicate a location of where the customer would like to pick up or have the found item transferred to. For example, the customer may live in San Francisco, Calif. and want the item to be transferred the establishment's location in San Francisco.

In another example, the customer may have flown from Charlotte, N.C. to San Diego, Calif. for a one-day meeting. After flying back to Charlotte, the customer remembered that he left his phone charger on the plane to San Diego. The customer may notify the agent in Charlotte of the lost phone charger. Thus, the destination location may be Charlotte, N.C. as that is where the customer lives and is able to pick up the found item.

The lost item report may also include a return option data field 322. The return option data field may include information of how the customer would like the item returned. For example, the customer may want to personally pick up the found item, have the found item mailed to a specific address, or any other known delivery options.

The lost item report 300 may also have a timestamp 324 so that after a predetermined amount of time (e.g. 30 days, 3 months, 6 months), older lost item reports may be removed and deleted. In one embodiment, the lost item date and/or timestamp may be compared with a found item date and/or timestamp in a found item report to determine if the lost item report 300 matches the found item report.

The lost item report 300 may be transmitted to a server, such as recovery server 108 illustrated in FIG. 1. If a found item report is matched with the lost item report 300, the lost item report may have a status indicator 316 to indicate the status of the lost item report. As illustrated, the found item has been claimed and/or received 316. In another embodiment, the status indicator 316 may indicate that the found item is discarded if the customer did not want the found item to be returned. In still another embodiment, the status indicator 316 may indicate a match with a found item report has been found. The status indicator 316 may indicate any other status of the found item as desired such as mailed, shipped, on hold, and the like.

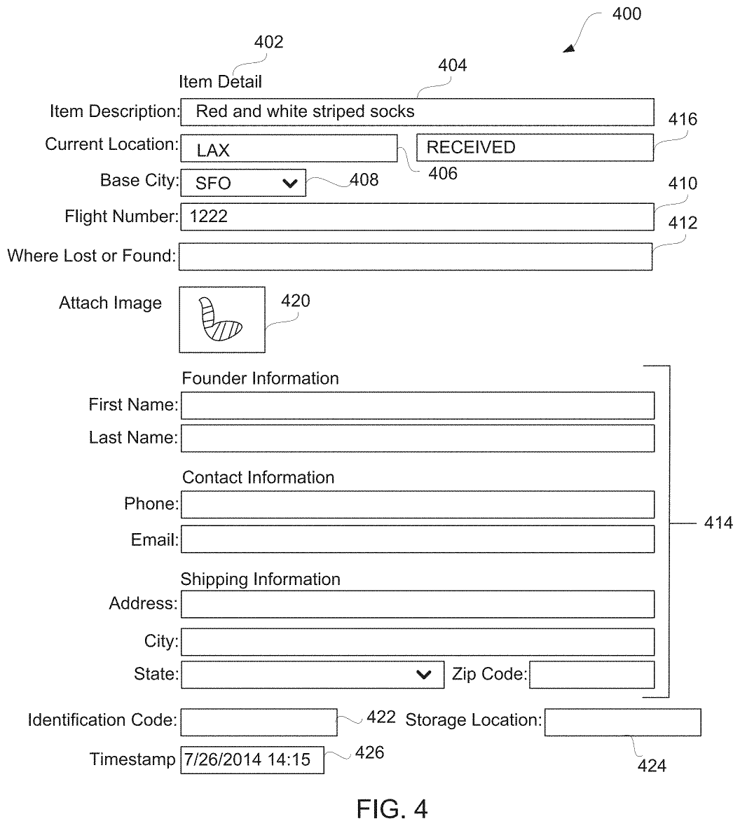

FIG. 4 illustrates an example found item report. When the lost item is found and becomes a found item, a found item report 400 may be generated. The found item report 400 may include a plurality of data fields such as founder information 414, item details 402 such as the current location of the found item 412, and any other desired information. The founder information 414 may include information of the person that found the found item such as name, phone number, address, electronic mail address, and any other information about the founder.

The item detail 402 may include information such as the location of where the item was found 412. The location of where the item was found may include a business name, room number, seat number, and/or additional location information or data of where the item was found. The location may be a general location, such as “Flight 123”, or “Section A in the pool area”. The location may also be a specific location, such as “Behind Seat 33A” or “Under red couch in lobby”.

The item detail 402 may also include a data field to input a found item description 404. As illustrated, the found item may be a “red and white striped socks” 404. The description of the lost item may include a general descriptive term as well as specific descriptive terms of the lost item to be used as keywords during a keyword search. For example, a general descriptive term may be a “Phone charger” and the specific descriptive term may be “Black iPhone 5 phone charger”. In another example, the general descriptive term may be “clothing” and the specific descriptive term may be “black and white adult socks”. The detailed descriptive terms may include any information such as color, shape, manufacturer, and any other characteristic of the lost item. The found item description may also include an image 420 of the found item to enhance or increase the chances for identification or a match with a lost item.

In one embodiment, the establishment illustrated in FIG. 4 may be an airline. Thus, other additional item detail data 402 may include the current location 406 of where the found item report is generated, the base city 408 for the establishment, flight number 410 of the plane, location of the custody center for the airline, and any other desired information.

The found item may be assigned a unique identifier or identification code 422 and a storage location 424. The identification code 422 may be any unique code that identifies the found item. For example, the unique code 422 may be any numerical or alphanumerical code that identifies or indicates the country, state, city, storage location, establishment location, and the like of the found item.

The found item report 400 may include a timestamp 426 so that after a predetermined amount of time (e.g. 30 days, 3 months, 6 months), older lost item reports and found item reports may be removed and deleted. In one embodiment, the found item date and/or timestamp may be compared with a lost item timestamp to determine if the found item report 400 matches a lost item report.

If the found item is not able to be stored at one establishment location, the found item may be transferred to another establishment location or a custody center of the establishment, such as custody center 104 illustrated in FIG. 1. Thus, the current location of the found item 406 and/or the identification code 422 may be periodically updated to indicate, in real-time, the location of where the found item is located. This also provides for a chain of custody for the found item.

The found item report 400 may be transmitted to a server, such as recovery server 108 illustrated in FIG. 1. In one embodiment, the found item report 400 may have a received indicator 416 to indicate the found item report was received and stored in a database, such as found item database 112 illustrated in FIG. 1. In another embodiment, if the found item report 400 is matched with a lost item report 300, the status indicator 416 may indicate the status of the match, such as “Match”. As illustrated, the found item has been claimed and/or received 416. In another embodiment, the status indicator 416 may indicate that the found item is discarded if the customer did not want the found item to be returned, such as “Discarded”. In still another embodiment, the status indicator 416 may indicate a match with a lost item report. The status indicator 416 may indicate any other status as desired such as mailed, shipped, on hold, and the like.

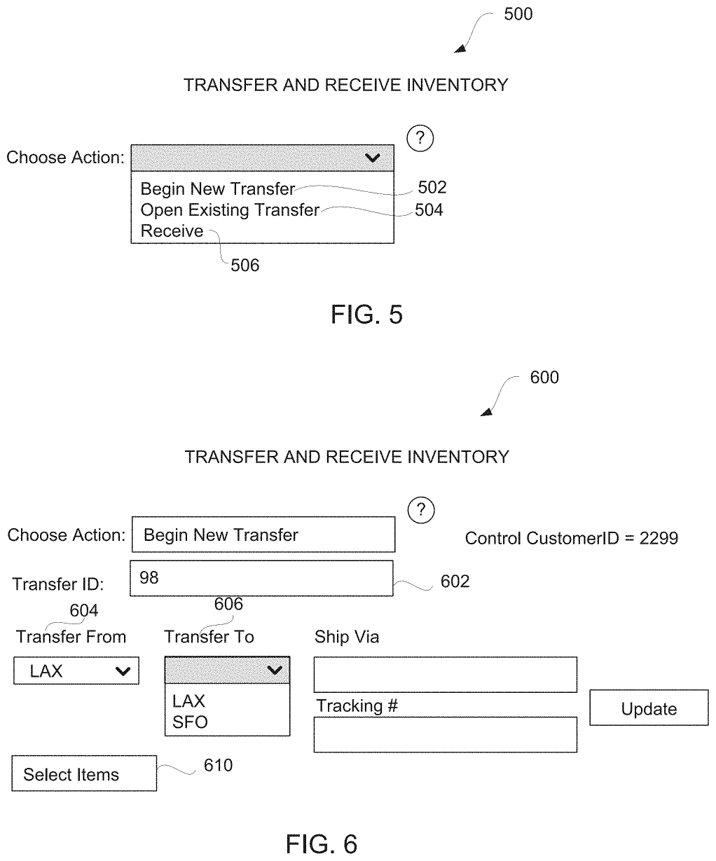

FIG. 5 illustrates an example graphical user interface to facilitate transfer of a found item. The graphical interface 500 may, in one embodiment, be a drop down menu to allow a user to select various options 500. The user may select to begin a new transfer request form 502, open an existing transfer request form 504, or select a prior transfer request form that is completed or received 506.

FIG. 6 illustrates an example transfer request form. The user may begin a new transfer request form 600 to transfer a found item to at least one of an establishment's locations. The transfer request form 600 may be assigned a unique identification code 602 to identify the transfer request. The transfer request form may allow the user to select the location where the found item is located at i.e. the transfer from location 604 and the location of where the found item should be transferred to 606. The transferred from and/or transferred to locations may be displayed via a dropdown menu or presented via any other known methods. As illustrated, the found item is to be transferred from LAX 604 to either LAX or SFO 606. Additionally, the user may select which items 610 to transfer.

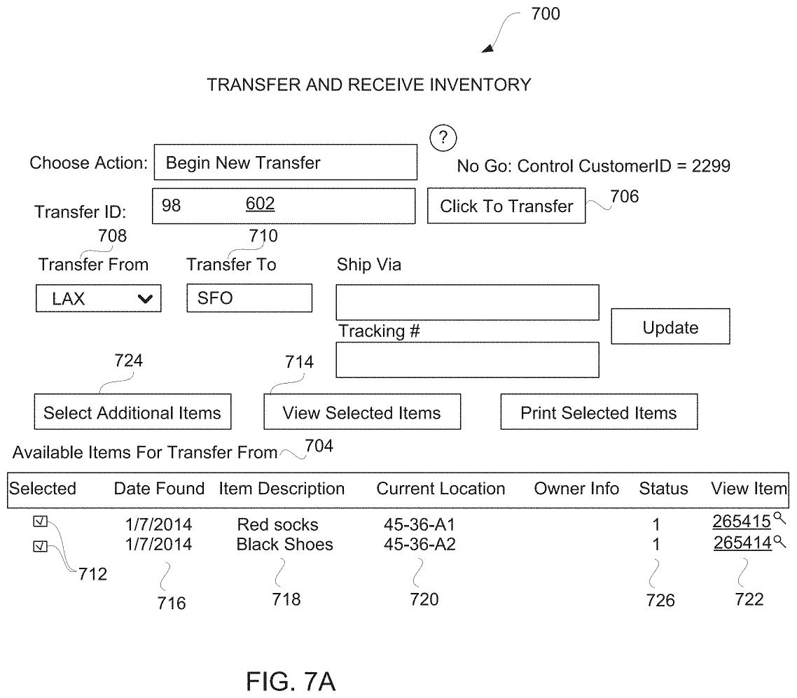

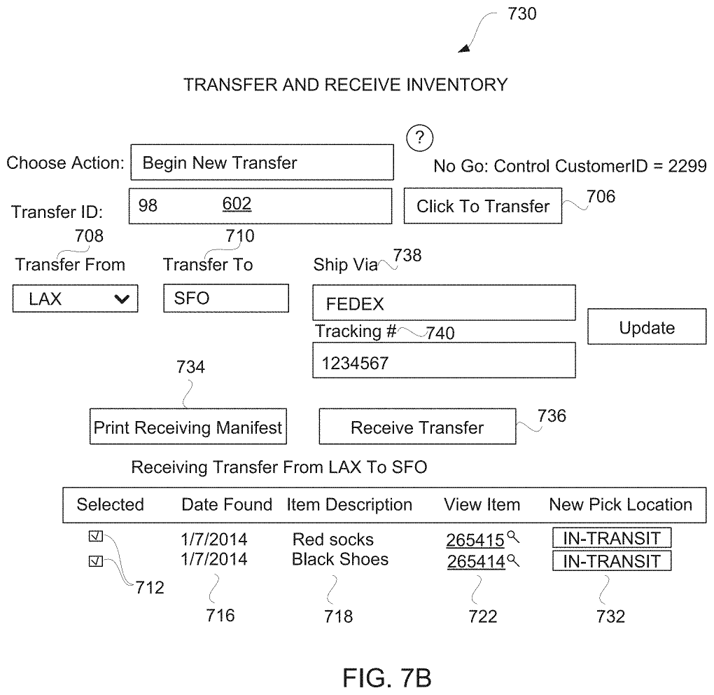

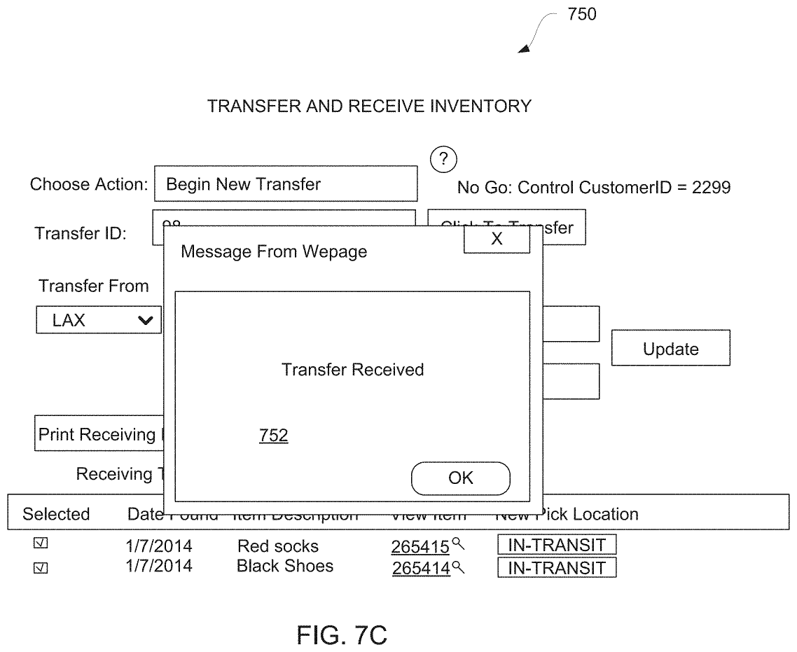

FIGS. 7A-7C further illustrate the example transfer request form of FIG. 6. Referring to FIG. 7A, the user may select to transfer a found item located at LAX 708 to SFO 710. A list of available items that are able to be transferred 704 from LAX to SFO may be listed. If the found item to be transferred is not listed on the transfer request form 700, the user may select “Select Additional Items” 724 to view additional items.

The list of available items 704 may include a selection indicator 712 to allow the user to select at least one found item report, date the found item was found 716, the found item description 718, unique identifier of the found item 722, the current location 720 of the found item, and a status indicator 726 of the found item. The selection indicator 712 allows the user to select which found items to transfer. The user may also view additional details of each found item by selecting the “View Selected Items” indicator 714. If the “View Selected Items” 712 is selected, the user will be able to view the found item report to view detailed and/or additional information about the found item. As illustrated, both selection indicators 712 are selected.

The date the found item was found 716 and the item description 718 may be obtained from a found item report. As illustrated, both items were found on Jan. 7, 2014 716. One found item is “Red socks” and the other is “Black shoes” 718. The current location 720 of the found item may be listed to inform the user where the found item is stored or located. As illustrated, the current location 720 may be a numerical identifier. In another embodiment, the current location 720 may be a description of the physical location such as “Room 3, shelf 2, box 15”. The current location 720 may be any identifier that indicates the location of the found item.

The status indicator 726 may be any desired indicator of the status of the found item that may be periodically updated. For example, “1” may indicate that the found item report has not been matched. In another example, a status indicator of “2” may indicate that a potential match with a lost item report has been found. In still another example, a status indicator of “3” may indicate that the item has been transferred. In yet still another example, the status indicator may indicate that the item has been shipped to the customer. In other words, the status indicator 726 may be indicate any status as desired by a user.

Each found item report may also have a unique identifier 722 that helps to efficiently locate or find a found item report. In one embodiment, the user may select the unique identifier 722 to view additional details in the found item report.

Referring to FIG. 7B, the establishment may select a shipment method 738 to transfer the found time. As illustrated, the found item may be shipped via FedEx™ 738 and may be assigned a tracking number 740. However, other shipment methods 738 may be used such as via UPS™, United States Postal Service, DHL™, common carrier, local delivery service, and any other service provider. Once the found items to be transferred are selected 712, the user may select the transfer button or indicator 706 to initiate transfer of the found items. Once selected, the found items may be prepared for shipping and the found item reports may be updated to indicate that the found items are “In-Transit” 732.

In one embodiment, the graphical interface may allow the user to print a manifest 734. In another embodiment, once the found item has been successfully transferred and receive at the destination, the “Receive Transfer” 736 may be selected. If selected, in one embodiment, the status indicator 726 may be updated to reflect that the found item is received at the destination.

Referring now to FIG. 7C, once the transfer indicator 706 is selected, the user may receive a notification that the transfer request was received 752.

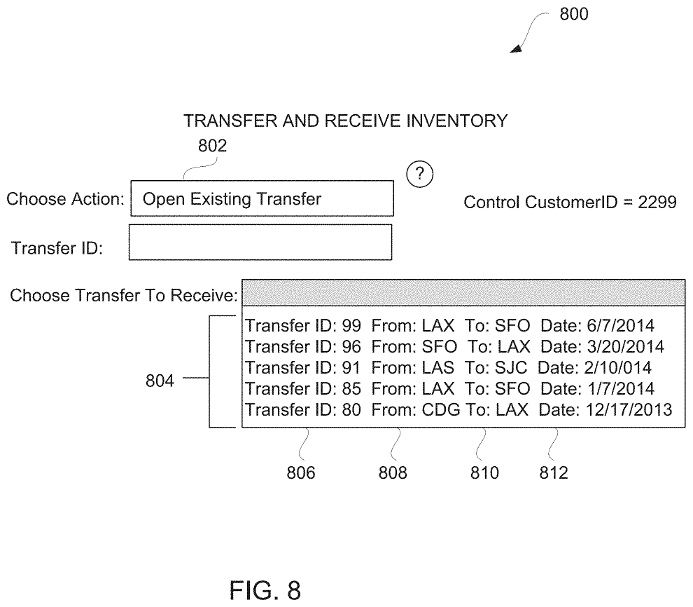

FIG. 8 illustrates an example graphical user interface illustrating a list of existing transfer requests. If a user desires to view existing transfer requests 802, a list of transfer request forms 804 may be presented on the graphical user interface 800. The list may include the transfer identifier 806, the transfer from location 808, transfer to location 810, as well as the date the transfer was requested 812. This allows a user to efficiently view all transfer request forms.

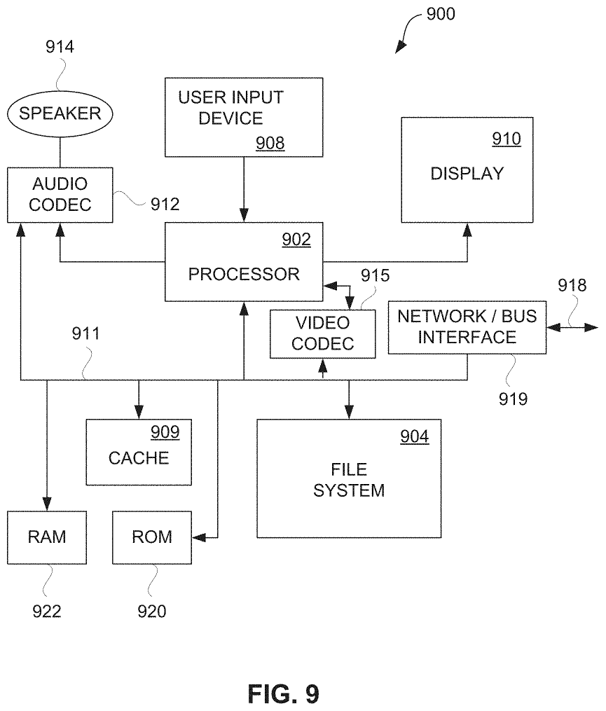

FIG. 9 illustrates a block diagram of a computing device according to one embodiment. The computing device 900 can represent circuitry of a representative computing device (e.g. client device, recovery sever, report server, transfer manager, shipment manager, establishment server) described and illustrated in FIG. 1. The computing device can be designed to primarily stationary or can be portable.

The computing device 900 includes a processor 902 that pertains to a microprocessor or controller for controlling the overall operation of the computing device 900. The computing device 900 stores media data pertaining to media items in a file system 904 and a cache 906. The file system 904 is, typically, semiconductor memory (e.g., Flash memory) and/or one or more storage disks. The file system 904 typically provides high capacity storage capability for the computing device 900. However, since the access time to the file system 904 can be relatively slow, the computing device 900 can also include the cache 906. The cache 906 is, for example, Random-Access Memory (RAM). The relative access time to the cache 906 is typically shorter than for the file system 904. However, the cache 906 does not have the large storage capacity of the file system 904. The computing device 900 also includes a RAM 920 and a Read-Only Memory (ROM) 922. The ROM 922 can store programs, utilities or processes to be executed in a non-volatile manner. The RAM 920 provides volatile data storage, such as for the cache 906.

The computing device 900 may also include a user input device 908 that allows a user of the computing device 900 to interact with the computing device 900. For example, the user input device 908 can take a variety of forms, such as a button, keypad, dial, touch-sensitive surface, etc. Still further, the computing device 900 includes a display 910 (screen display) that can be controlled by the processor 902 to display information to the user. A data bus 911 can facilitate data transfer between at least the file system 904, the cache 906, the processor 902, an audio coder/decoder (CODEC) 912 and/or a video CODEC 915.

In one embodiment, for example, if the computing device 900 (e.g. client device 102a-n, establishment server 104 illustrated in FIG. 1) is a media player, the computing device 900 may store a plurality of media items (e.g., songs, videos, podcasts, etc.) in the file system 904. When a user desires to have the computing device play a particular media item, a list of available media items is displayed on the display 910. Then, using the user input device 908, a user can select one of the available media items. The processor 902, upon receiving a selection of a particular media item, supplies the media data to one or more appropriate output devices. If the particular media item is encrypted, the particular media item is first decrypted as noted above, which could involve one or more layers of encryption. As an example, for audio output, the processor 902 can supply the media data (e.g., audio file) for the particular media item to the audio CODEC 912. The audio CODEC 912 can then produce analog output signals for a speaker 914. The speaker 914 can be a speaker internal to the computing device 900 or external to the computing device 900. For example, headphones or earphones that connect to the computing device 900 would be considered an external speaker. As another example, for video output, the processor 902 can supply the media data (e.g., video file) for the particular media item to the video CODEC 915. The video CODEC 915 can then produce output signals for the display 910 and/or the speaker 914.

The computing device 900 also includes a network/bus interface 916 that couples to a data link 918. The data link 918 allows the computing device 900 to couple to another device (e.g., a host computer, a power source, or an accessory device). The data link 918 can be provided over a wired connection or a wireless connection. In the case of a wireless connection, the network/bus interface 916 can include a wireless transceiver.

The various aspects, features, embodiments or implementations of the invention described above can be used alone or in various combinations. Embodiments of the invention can, for example, be implemented by software, hardware, or a combination of hardware and software. Embodiments of the invention can also be embodied as computer readable code on a computer readable medium. The computer readable medium is any data storage device that can store data which can thereafter be read by a computer system. Examples of the computer readable medium generally include read-only memory and random-access memory. More specific examples of computer readable medium are tangible and include Flash memory, EEPROM memory, memory card, CD-ROM, DVD, hard drive, magnetic tape, and optical data storage device. The computer readable medium can also be distributed over network-coupled computer systems so that the computer readable code is stored and executed in a distributed fashion.

Numerous specific details are set forth in order to provide a thorough understanding of the present invention. However, it will become obvious to those skilled in the art that the invention may be practiced without these specific details. The description and representation herein are the common meanings used by those experienced or skilled in the art to most effectively convey the substance of their work to others skilled in the art. In other instances, well-known methods, procedures, components, and circuitry have not been described in detail to avoid unnecessarily obscuring aspects of the present invention.

In the foregoing description, reference to “one embodiment”, “an embodiment”, “one example” means that a particular feature, structure, or characteristic described in connection with the embodiment can be included in at least one embodiment of the invention. The appearances of the phrase “in one embodiment” in various places in the specification are not necessarily all referring to the same embodiment, nor are separate or alternative embodiments mutually exclusive of other embodiments. Further, the order of blocks in process flowcharts or diagrams representing one or more embodiments of the invention do not inherently indicate any particular order nor imply any limitations in the invention.

1. A system for the transfer of found items between different establishment locations associated with an entity, comprising:
a lost item database storing a record for each of a plurality of lost items, wherein, for each lost item, the record having at least a lost item description, a lost item location, and a destination location;
a found item database including a record for each of a plurality of found items, wherein, for each found item, the record having at least a found item description and a found item location;
at least one server configured to search the found item database for a found item that matches a lost item in the lost item database, the at least one server configured to at least (i) determine if a lost item description recorded in the lost item database matches a found item description recorded in the found item database as a matched found item and a matched lost item, and (ii) determine if a found item location for the matched found item matches a destination location for the matched lost item; and
a transfer manager configured to manage transfer of the matched found item from the found item location to the destination location.

2. A system as recited in claim 1, wherein after the matched found item has been successfully transferred to the destination location, the at least one server is configured to at least updated the found item database to reflect the current location of the matched found item as being at the destination location.

3. A system as recited in claim 2, wherein the found item location and the found item location are different establishment locations associated with a single entity.

4. A system as recited in claim 3, wherein the at least one server is configured to
transmit an establishment transfer notification to the establishment at the destination location, the establishment transfer notification informing the establishment at the destination location of the transfer of the matched found item to the destination location.

5. A system as recited in claim 5, wherein the at least one server is configured to
transmit a user transfer notification to a user associated with the matched lost item, the user transfer notification informing the user associated with the matched lost item of the transfer of the matched found item to the destination location.
